(19) United States
(12) Patent Application Publication
(10) Pub. No.: US 2013/0258664 A1
(43) Pub. Date: Oct. 3, 2013

(54) ILLUMINATION DEVICE

(71) Applicants: Zhi-Ting Ye, Miaoli County (TW); Chin-Liang Chen, Taichung City (TW); Ming-Chuan Lin, Taichung City (TW)

(72) Inventors: Zhi-Ting Ye, Miaoli County (TW); Chin-Liang Chen, Taichung City (TW); Ming-Chuan Lin, Taichung City (TW)

(73) Assignees: WINTEK CORPORATION, Taichung City (TW); Dongguan Masstop Liquid Crystal Display Co., Ltd., Guangdong Province (CN)

(21) Appl. No.: 13/845,128

(22) Filed: Mar. 18, 2013

(30) Foreign Application Priority Data
Mar. 20, 2012 (TW) 101109531

(51) Int. Cl. F21V 13/04

(52) U.S. Cl. CPC F21V 13/04
USPC 362/237

(57) ABSTRACT

An illumination device includes a light guide bar and light sources. The light guide bar includes a reflective layer, a light-emitting surface opposite to the reflective layer, and a light-incident surface connecting the reflective layer and the light-emitting surface. The light sources are beside the light-incident surface. Each light source includes a light unit and a lens. The lens is between the LED and the light guide bar and includes two opposite planar portions and two opposite arc-surface portions to surround a light-emitting axis. The planar portions are adjacent to each other and form a valley line aligned to the light-emitting axis at a junction of the planar portions. The planar portions respectively face the reflective layer and the light-emitting surface with respect to the valley line; thus, light provided by the LED is partially emitted toward the reflective layer and the light-emitting surface through the planar portions, respectively.

### CROSS-REFERENCE TO RELATED APPLICATION

This application claims the priority benefit of Taiwan application serial no. 101109531, filed on Mar. 20, 2012. The entirety of the above-mentioned patent application is hereby incorporated by reference herein and made a part of this specification.

### BACKGROUND OF THE INVENTION

1. Field of the Invention

The invention relates to an illumination device. More particularly, the invention relates to an illumination device equipped with lenses capable of converging light emitted at different angles.

2. Description of Related Art

A light-emitting diode (LED) is a semiconductor device. The service life of the LED often exceeds a hundred thousand hours, and the LED does not require idling time. Moreover, the LED has advantages of fast response speed (approximately 10⁻⁹ seconds), compact size, low power consumption, low pollution, high reliability, capability for mass production, etc. Therefore, the application of LED is fairly extensive, for instance, mega-size outdoor display boards, traffic lights, cell phones, light sources of scanners and facsimile machines, illumination devices, and so forth.

Since the brightness and the light-emitting efficiency of LED continue to increase, and mass production of white LED succeeds, the LED has been gradually applied for illumination. However, in order to comply with the requirement for brightness, a plurality of LEDs as the light sources for illumination or the light sources of a display are often configured in the illumination device to guarantee the brightness. FIG. 1 is a schematic view illustrating a conventional illumination device having a plurality of light sources. Combination of plural light sources may enhance the overall brightness of the illumination device. However, after light emitted from the light sources 120 enters the conventional illumination device 100 through the light-incident surface 110a of the light guide bar 110, the light is reflected by the top surface 110b or the bottom surface 110c of the light guide bar 110 and then directly emitted from the front end 110f of the top surface 110b of the light guide bar 110. Thereby, the light cannot be effectively utilized, and the issue of light leakage may occur. Accordingly, the light utilization rate of the conventional illumination device 100 is unsatisfactory.

### SUMMARY OF THE INVENTION

The invention is directed to an illumination device capable of effectively utilizing light provided by light sources, increasing the light utilization rate, and ensuring light-emitting uniformity.

In an embodiment of the invention, an illumination device that includes a light guide bar and a plurality of light sources is provided. The light guide bar includes a reflective layer, a light-emitting surface opposite to the reflective layer, and a light-incident surface connecting the reflective layer and the light-emitting surface. The light sources are located beside the light-incident surface, and each of the light sources includes a light unit such as light-emitting diode (LED) and a lens. The lens is located between the light unit and the light guide bar and constituted by two planar portions opposite to each other and two arc-surface portions opposite to each other to surround a light-emitting axis. The two planar portions are adjacent to each other and form a valley line aligned to the light-emitting axis at a junction of the two planar portions. The two planar portions respectively face the reflective layer and the light-emitting surface with respect to the valley line as a base line, such that light provided by the light unit is partially emitted toward the reflective layer and the light-emitting surface through the two planar portions of the lens, respectively.

According to an embodiment of the invention, the two planar portions in each of the lenses have an included angle θ at the junction, and the included angle θ ranges from about 90 degrees to about 120 degrees, for instance.

According to an embodiment of the invention, one of the two planar portions in each of the lenses and the reflective layer are located at one side of the light-emitting axis, and the other planar portion and the light-emitting surface are located at the other side of the light-emitting axis.

According to an embodiment of the invention, one of the two planar portions in each of the lenses is aligned to the reflective layer along a cross-section of an axis of the light guide bar, and the other planar portion and is aligned to the light-emitting surface along the cross-section of the axis of the light guide bar.

According to an embodiment of the invention, the two arc-surface portions in each of the lenses are respectively adjacent to the two planar portions and respectively located at two sides of the reflective layer along a cross-section of an axis of the light guide bar.

According to an embodiment of the invention, one of the two planar portions in each of the light sources faces the reflective layer and has a normal vector, and an included angle between the reflective layer and the normal vector of the planar portion facing the reflective layer ranges from about 45 degrees to about 60 degrees.

According to an embodiment of the invention, one of the two planar portions in each of the light sources is away from the reflective layer and has a normal vector, and an included angle between the light-emitting layer and the normal vector of the planar portions away from the reflective layer ranges from about 45 degrees to about 60 degrees.

According to an embodiment of the invention, an area where the light sources are arranged is smaller than an area of the light-incident surface, and centers of locations of the light sources are aligned to an axis of the light guide bar.

According to an embodiment of the invention, each of the lenses has a bottom surface, the two planar portions and the two arc-surface portions respectively extend from the valley line to the bottom surface, and the light unit is located at a center of the bottom surface.

According to an embodiment of the invention, the light-incident surface is located at an end portion of the light guide bar, the light-emitting surface is located on a circumferential surface of the light guide bar, the circumferential surface has a plane parallel to an axis of the light guide bar, and the reflective layer is located on the plane to form a reflective plane.

Based on the above, in each light source of the illumination device described in the embodiments of the invention, two opposite planar portions having a valley line at a junction of the two opposite planar portions and facing the light guide bar are configured on the lens, while the rest of the lens is divided into two arc-surface portions. The two planar portions respectively face the reflective layer and the light-emitting surface with respect to the valley line as a base line, and light emitted from the light unit toward the reflective layer and the light-emitting surface at different emitting angles can be effectively converged by means of the two planar portions. Thereby, light emitted toward the reflective layer and the light-emitting layer may be totally reflected in the light guide bar, and the light may be transmitted along the axis direction of the light guide bar. As such, the light-emitting uniformity can be guaranteed, and the light utilization rate of the illumination device can be increased.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic view illustrating a conventional illumination device having a plurality of light sources.

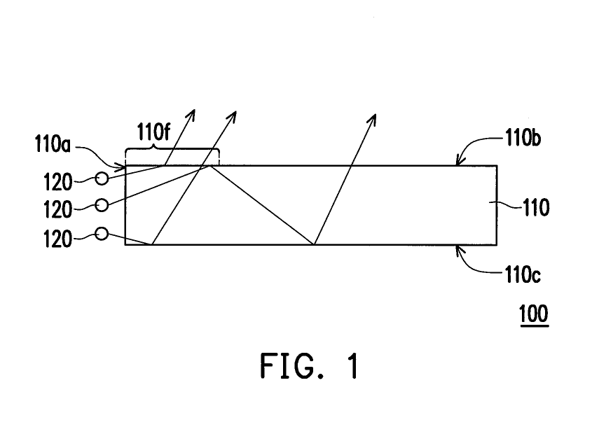

FIG. 2 is a schematic exploded view illustrating an illumination device according to an embodiment of the invention.

FIG. 3A is a schematic cross-sectional view illustrating optical effects achieved by the lens depicted in FIG. 2 along a vertical direction according to an embodiment of the invention.

FIG. 3B is a top perspective view illustrating the bottom reflective layer of the illumination device according to an embodiment of the invention, and the reflective layer is observed from one side of the light-emitting surface of the light guide bar through the light guide bar depicted in FIG. 2.

FIG. 4 is a side view of the illumination device observed from an end of the light guide bar.

FIG. 5 is a schematic view illustrating a light path of the illumination device according to an embodiment of the invention.

FIG. 6 is a schematic view illustrating illumination distribution of light sources in the illumination device according to an embodiment of the invention.

FIG. 7A is a schematic view illustrating illumination distribution in a conventional illumination device, and FIG. 7B is a schematic view illustrating illumination distribution correspondingly taken along the line segment B1 depicted in FIG. 7A

FIG. 8A is a schematic view illustrating illumination distribution in an illumination device according to an embodiment of the invention, and FIG. 8B is a schematic view illustrating illumination distribution correspondingly taken along the line segment B2 depicted in FIG. 8A

### DESCRIPTION OF EMBODIMENTS

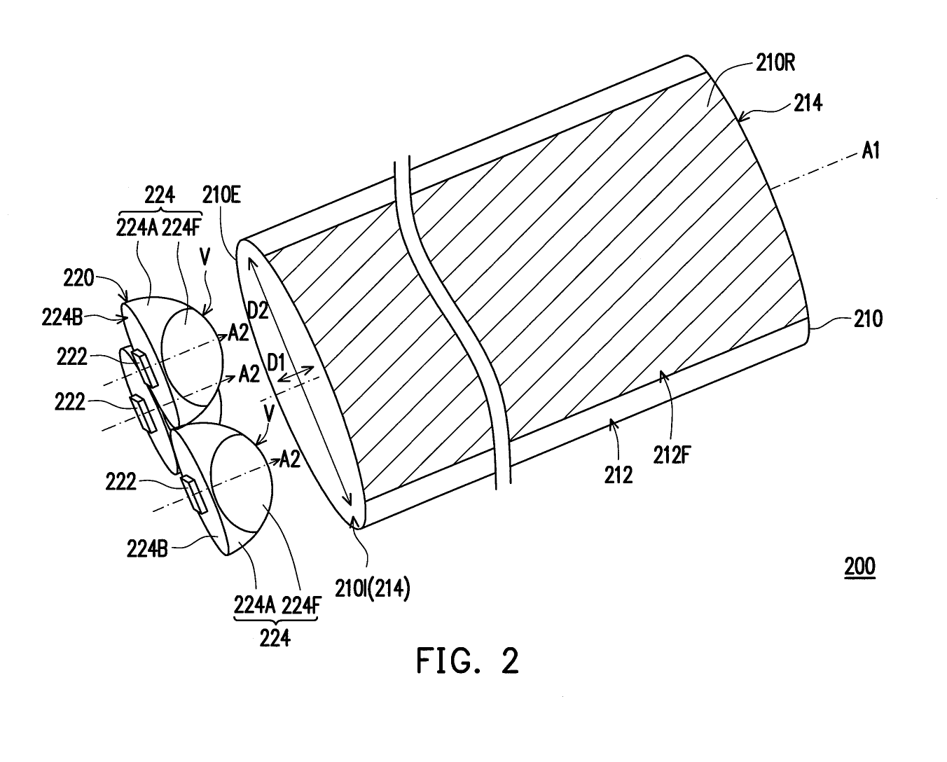

FIG. 2 is a schematic exploded view illustrating an illumination device according to an embodiment of the invention. With reference to FIG. 2, the illumination device 200 includes a light guide bar 210 and a plurality of light sources 220 located beside a light-incident surface 210I of the light guide bar 210. Each of the light sources 220 includes a light unit 222 such as light-emitting diode (LED) and a lens 224. As indicated in FIG. 2, the light unit 222, the lens 224, and the light guide bar 210 are sequentially arranged along an axis A1 of the light guide bar 210, for instance. According to the present embodiment, an area where the light sources 220 are arranged on an end surface of the light guide bar 210 is smaller than an area of the light-incident surface 210I, for instance, and centers of locations of the light sources 220 are aligned to the axis A1 of the light guide bar 210.

As shown in FIG. 2, the light guide bar 210 includes a reflective layer 210R, a light-emitting surface 210E, and a light-incident surface 210I. Specifically, the light guide bar 210 described in the present embodiment is a cylinder whose height is much greater than its cross-sectional area, and the light guide bar 210 includes a circumferential surface 212 and two end portions 214. The light-incident surface 210I is located at one of the end portions 214, and the light sources 220 are located besides the end portion 214. The reflective layer 210R and the light-emitting surface 210E are located on the circumferential surface 212. In the present embodiment, one portion of the circumferential surface 212 is a curved surface or a cut plane 212F parallel to the axis A1 of the light guide bar 210. The reflective layer 210R is located on the plane 212F and is a diffusive reflective layer 210R made of white ink, for instance. In contrast to the above, the other portion of the circumferential surface 212 of the light guide bar 210 is substantially the light-emitting surface 210E. Namely, the illumination device 200 is capable of providing linear light.

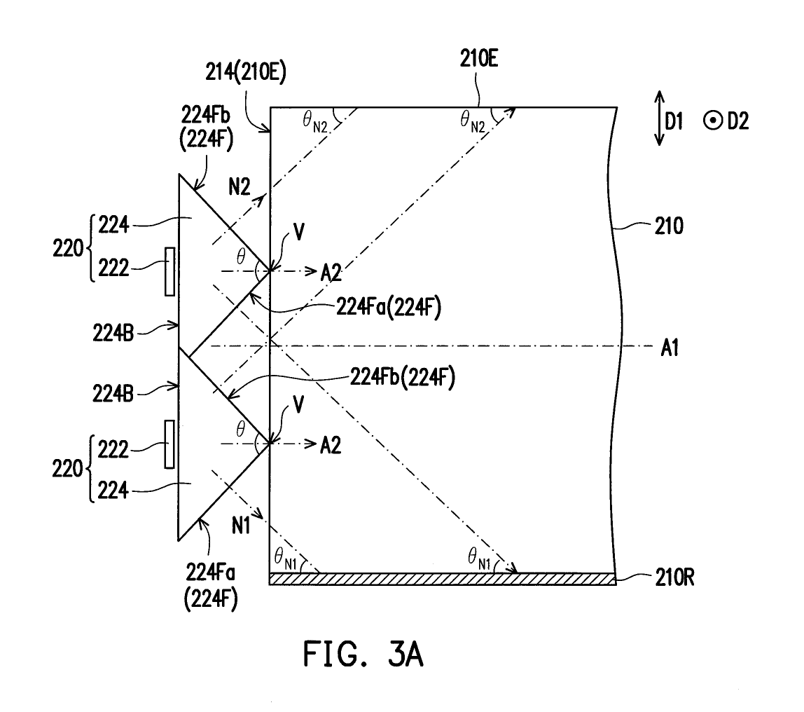

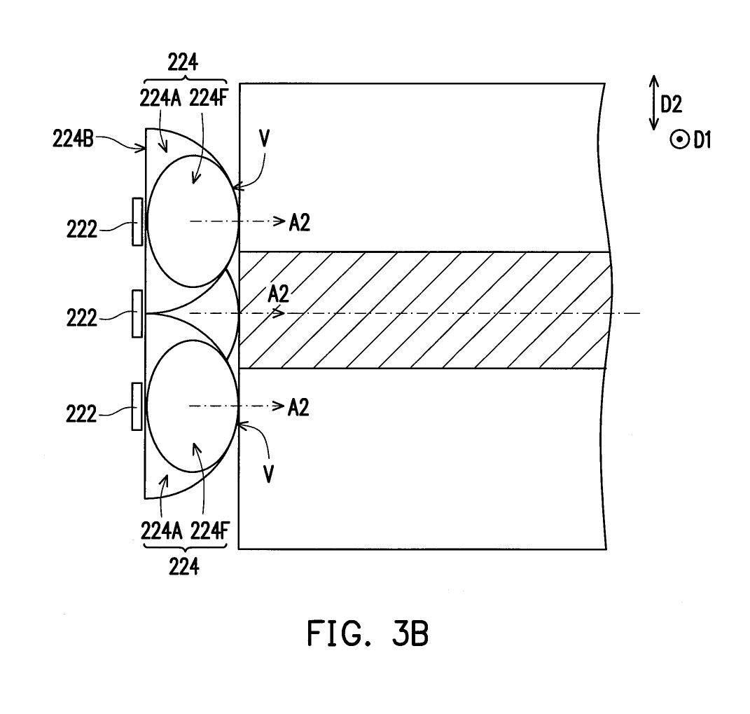

Note that the relative positions and the arrangements between the lenses 224 of the light sources 220 and the reflective layer 210R of the light guide bar 210 along the axis A1 of the light guide bar 210 have to be satisfied some specifically designs, so as to ensure the overall light-emitting uniformity of the illumination device 200. Specifically, for further illustrating the embodiments of the invention, the cross-sectional direction that is along the diameter of the light guide bar 210 through the reflective layer 210R is defined as a vertical direction D1, and a direction perpendicular to the vertical direction D1 and along the diameter of the light guide bar 210 is defined as a horizontal direction D2. The correlation between the design of lenses 224 of the light sources 220 and the light guide bar 210 is elaborated below with reference to FIG. 3A (schematically illustrating the cross-section of the illumination device 200 along the vertical direction D1) and FIG. 3B (a top perspective view illustrating the illumination device 200).

FIG. 3A is a schematic cross-sectional view illustrating the illumination device along the vertical direction depicted in FIG. 2. As shown in FIG. 2 and FIG. 3A, in each of the light sources 220, the emitting angle of the light from the light unit 222 emitted along the vertical direction D1 is modified by the two planar portions 224F of the lens 224. To be more specific, in order for the light emitted from each light unit 222 along the vertical direction D1 to be properly converged before the light enters the light guide bar 210, which prevents immediate light emission from light-emitting surface 210E after the light enters the light-incident surface 210I and the reflective layer 210 of the light guide bar 210, the lenses 224 of the illumination device 200 are required to be disposed between the light units 222 and the light guide bar 210, and the lenses 224 need to have a certain structure along the vertical direction D1. Each lens 224 is particularly constituted by two planar portions 224F and two arc-surface portions 224A to surround a light-emitting axis A2. The two planar portions 224F are opposite to each other, and the two arc-surface portions 224A are opposite to each other. Besides, an end of one planar portion 224F and an end of the other planar portion 224F are adjacent to each other and form a valley line V at a junction of the two planar portions 224F, and the valley line V is aligned to the light-emitting axis A2. Namely, if the light-emitting axis A2 is taken as a base axis, the arrangement sequence counting from one surface of the lens 224 is one of the planar portions 224F, one of the arc-surface portions 224A, the other planar portion 224F, and the other arc-surface portion 224A surround the light-emitting axis A2. Each of the lenses 224 has a bottom surface 224B. The two planar portions 224F and the two arc-surface portions 224A share the valley line V as the common apex and respectively extend from the valley line V to the bottom surface 224B. The light unit 222 is located at a center of the bottom surface 224B. Thereby, the light emitted from the light unit 222 enters the bottom surface 224B of the lens 224 and is emitted toward the mask-shaped body constituted by the two planar portions 224F and the two arc-surface portions 224A. Two sets of light respectively emitted from the two planar portions 224F and the two arc-surface portions 224A at different emitting angles then enter the light guide bar 210. Here, the light that passes the planar portions 224F and is emitted along the vertical direction D1 has a smaller emitting angle than that of the light passing the two arc-surface portions 224A and emitted along the horizontal direction D2.

As indicated in FIG. 3A, the two planar portions 224F in each lens 224 in the vertical direction D1 that passes the reflective layer 210R along the light guide bar 210 respectively face the reflective layer 210R and the light-emitting surface 210E with respect to the valley line V as a base line. Thereby, the light provided by the light unit 222 is emitted toward the reflective layer 210R and the light-emitting surface 210E through the two planar portions 224F, respectively. In FIG. 3A, the reflective layer 210R and one of the two planar portions 224F are located at the same side (first side) of the light-emitting axis A2, and the other planar portion 224F and the light-emitting surface 210E are located at the same side (second side) of the light-emitting axis A2, where the second side is opposite to the first side. For instance, the two planar portions 224F in each of the lenses 224 have an included angle θ at the junction where the valley line V is formed, and the included angle θ ranges from about 90 degrees to about 120 degrees, for instance.

Namely, in each of the lenses 224, one of the two planar portions 224F (i.e. planar portion 224Fa) a located at the same side (i.e. first side) of the light-emitting axis A2 with the reflective layer 210R is set by aligning the normal vector N1 of the planar portion 224Fa directed to the reflective layer 210R. An included angle θ_{N1} between the reflective layer 210R and the normal vector N1 of the planar portions 224Fa facing the reflective layer 210R ranges from about 45 degrees to about 60 degrees, for instance. On the other hand, the other of two planar portions 224F(i.e. planar portion 224Fb) located at the same side (i.e. second side which is opposite to the first side) of the light-emitting axis A2 with the light-emitting surface 210E is set by aligning the normal vector N2 of the planar portion 224Fb directed to the light-emitting surface 210E opposite to the reflective layer 210R. An included angle θ_{N2} between the light-emitting surface 210E and the normal vector N2 of the planar portions 224Fb away from the reflective layer 210R ranges from about 45 degrees to about 60 degrees, for instance.

The design of the lens 224 in each light source 220 and the relative position of the lens 224 and the light guide bar 210 allow the light emitted from the light unit 222 along different emitting angles to be converged by the two planar portions 224F of the lens 224, and the converged light then enters the light guide bar 210. Thereby, even though the light unit 222 is disposed overly close to the periphery of the light guide bar 210, the light immediately emitted from an interface between the light guide bar 210 and atmosphere (caused by the excessive incident angle of light) after entry into the light guide bar 210 can be prevented, and the resultant light leakage can be precluded as well. Namely, the planar portions 224F are conducive to convergence of incident light emitted along different emitting angles. As such, light emitted from plural light units at different locations can be well transmitted within the light guide bar 210, and thereby the light-emitting uniformity can be enhanced. In other words, the lens 224 having the planar portions 224F can improve the overall light-emitting uniformity and light utilization rate of the illumination device 200.

FIG. 3B is a top perspective view illustrating the bottom reflective layer of the illumination device according to an embodiment of the invention, and the reflective layer is observed from one side of the light-emitting surface of the light guide bar through the light guide bar depicted in FIG. 2. As shown in FIG. 3B, the lens 224 has two opposite planar portions 224F respectively facing the reflective layer 210R and the light-emitting surface 210E opposite to the reflective layer 210R, and a valley line V is formed at the junction of one end of each planar portion 224F. Thereby, the light emitted from the light unit 222 along the cross-section of the reflective layer 210R at different emitting angles can be effectively converged. Besides, the lens 224 has two arc-surface portions 224A along the horizontal direction D2, and the two arc-surface portions 224A are respectively located at two sides of the planar portions 224F. Thereby, the light-emitting efficiency that is slightly reduced after light is converged by the two planar portions 224F can be improved. Namely, the two arc-surface portions 224A along the horizontal direction D2 may enhance the light-emitting efficiency of converged light and improve the overall light-emitting efficiency that is slightly reduced after light is converged by the two planar portions 224F. As such, the illumination device can have light-emitting uniformity without sacrificing the overall light-emitting efficiency.

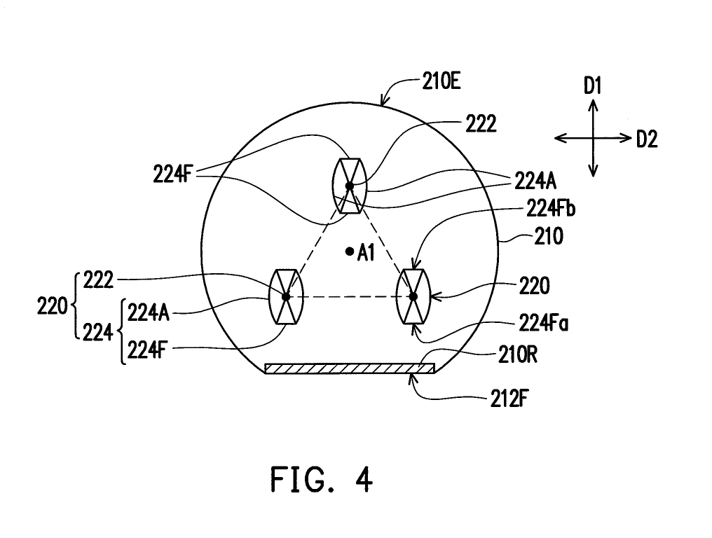

FIG. 4 is a side view of the illumination device observed from an end of the light guide bar. The center around which the light sources 220 are arranged (e.g., the center of the triangle shown in FIG. 4) is aligned to the axis A1 of the light guide bar 210. One of the two planar portions 224F in each lens 224 (e.g., the planar portion 224Fa) faces the reflective layer 210R along the cross-section of the axis of the light guide bar 210 (i.e. the cross-section is along the diameter of the light guide bar 210) and is aligned to the reflective layer 210R. The other planar portion 224F in each lens 224 (e.g., the planar portion 224Fb) faces the light-emitting surface 210E along the cross-section of the axis of the light guide bar 210 and is aligned to the light-emitting surface 210E. As indicated in FIG. 4, the two arc-surface portions 224A in each of the lenses 224 are arranged along the horizontal direction D2 and are respectively adjacent to the two planar portions 224F. Besides, the two arc-surface portions 224A along the cross-section of the axis of the light guide bar 210 respectively face a side of the light-emitting surface 210E connecting two sides of the reflective layer 210R.

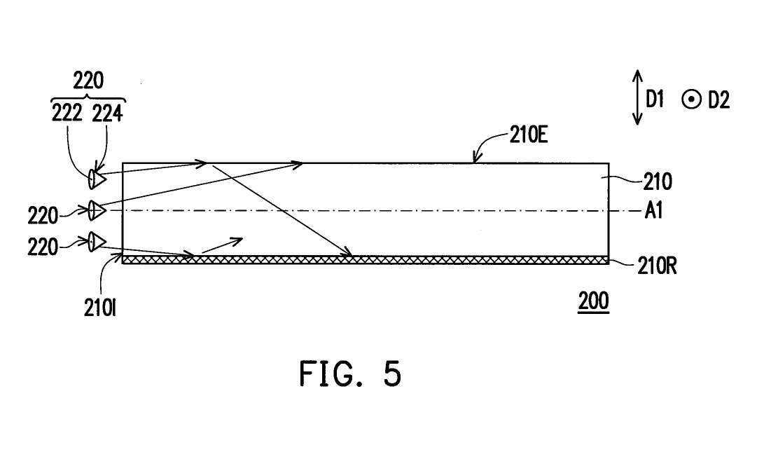

With reference to FIG. 5, the two planar portions 224F in each lens 224 of the illumination device 200 described herein are conducive to convergence of light before light from each light source 220 enters the light guide bar 210. If plural light sources 220 are configured in front of the light-incident surface of the illumination device 220, the light from the light sources 220 at difference locations may properly enter the light guide bar 210. Thereby, the immediate light emission after the light enters the light guide bar 210 and the light leakage at the front end of the light guide bar 210 can both be prevented.

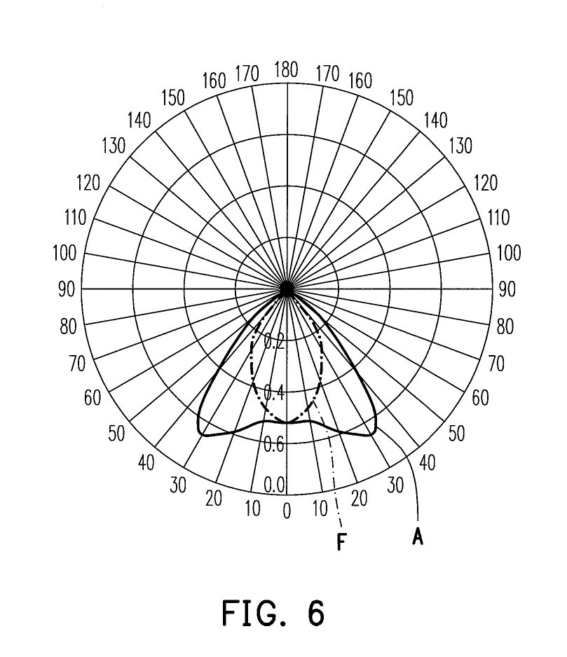

FIG. 6 is a schematic view illustrating illumination distribution of light sources in the illumination device according to an embodiment of the invention. As shown in FIG. 6, the curve F represents the light shape distribution after the light emitted from the light unit 222 passes the two planar portions 224F of the lens 224, and the curve A represents the light shape distribution after the light emitted from the light unit 222 passes the two arc-surface portions 224A of the lens 224. In FIG. 6, the curve F is more convergent than the curve A, which indicates that the light emitted from the light unit 222 and passing the two planar portions 224F may have a emitting angle smaller than that of the light passing the two arc-surface portions 224A.

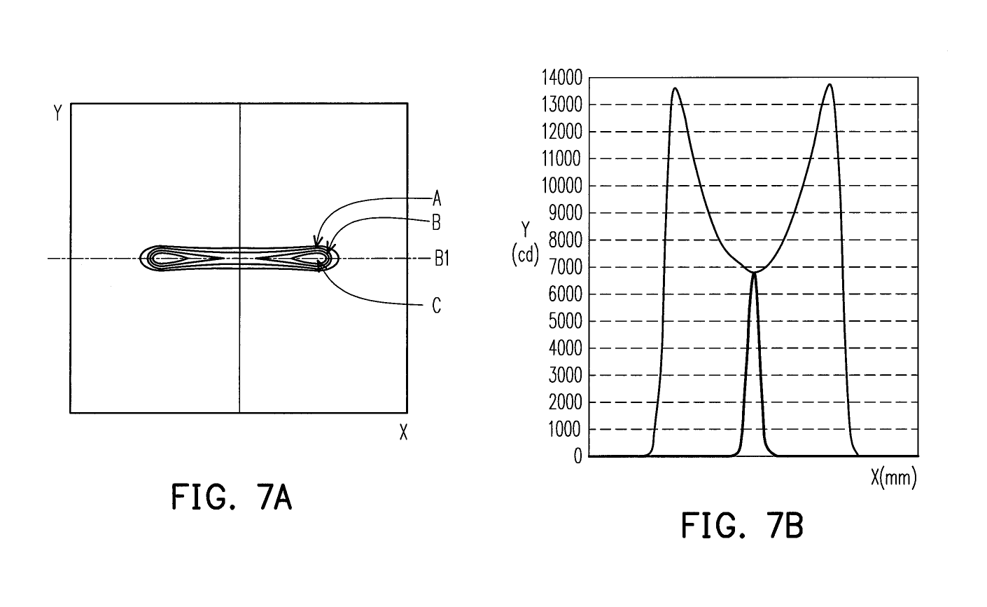

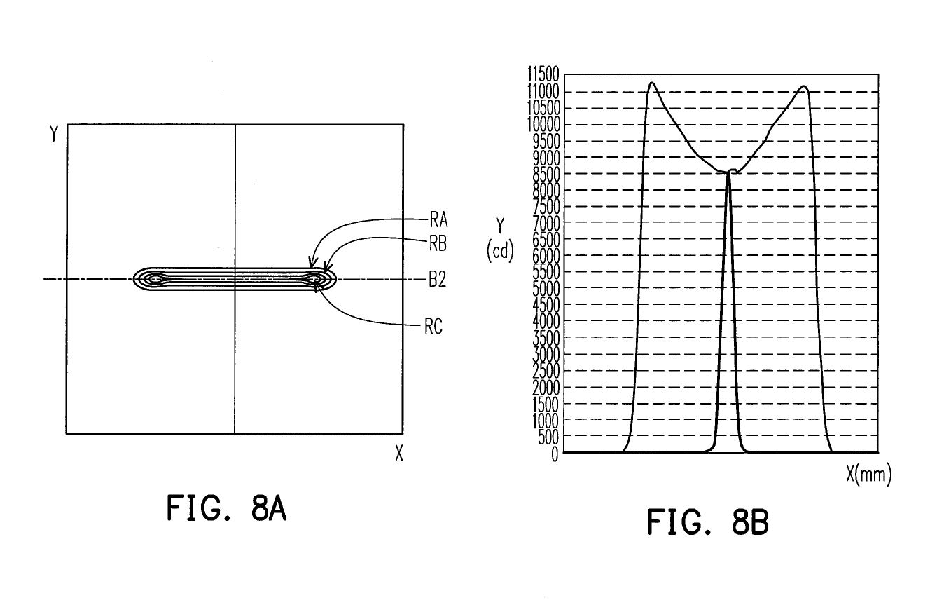

FIG. 7A is a schematic view illustrating illumination distribution in a conventional illumination device, and FIG. 7B is a schematic view illustrating illumination distribution correspondingly taken along the line segment B1 depicted in FIG. 7A. Here, the light sources in the conventional illumination device do not equipped with the lenses each having two planar portions and two arc-surface portions. FIG. 8A is a schematic view illustrating illumination distribution in an illumination device according to an embodiment of the invention, and FIG. 8B is a schematic view illustrating illumination distribution correspondingly taken along the line segment B2 depicted in FIG. 8A. With reference to FIGS. 7A-7B and FIGS. 8A-8B, x axis and y axis of FIG. 7A and FIG. 8A respectively represents the relative position (mm) of the light emitting surface of the illumination device, x axis of FIG. 7B and FIG. 8B represents the relative position (mm), y axis of FIG. 7B and FIG. 8B represents the illumination (cd), and regions RA, RB, and RC respectively denote different illumination. Here, the illumination of the region RC is greater than the illumination of the region RB, and the illumination of the region RB is greater than the illumination of the region RA. Upon the comparison between FIG. 7A and FIG. 8A, it can be learned that the lens 224 in each light source 220 of the illumination device 200 described herein has two arc-surface portions 224A and two planar portions 224F, and the two planar portions 224F respectively face the reflective layer 210R of the light guide bar 210 and the light-emitting surface 210E opposite to the reflective layer 210R. Thereby, the problem that light is concentrated and emitted from the front end of the light guide bar 210 can be solved, and the illumination device 200 described herein can have uniform illumination in comparison with the conventional illumination device.

In addition, according to the comparison between FIG. 7B and FIG. 8B, when the illumination uniformity is defined as (the maximum illumination-the minimum illumination)/the maximum illumination, the illumination uniformity of the conventional illumination device shown in FIG. 7B is 40.5%, while the illumination uniformity of the illumination device 200 shown in FIG. 8B is 25.2%. Accordingly, the illumination uniformity (defined as a difference between the maximum illumination and the minimum illumination) of illumination device 200 of present embodiment is smaller than that of the conventional illumination device (defined as a difference between the maximum illumination and the minimum illumination). As a result, compared to the light-emitting uniformity of the conventional illumination device, the light-emitting uniformity of the illumination device 200 described herein can be improved by 15% or more.

To sum up, in each light source of the illumination device described in the embodiments of the invention, two opposite planar portions having a valley line at a junction of the two opposite planar portions and facing the light guide bar are configured on the lens, while the rest of the lens is divided into two arc-surface portions. The two planar portions respectively facing the reflective layer and the light-emitting surface at two sides of the light guide bar are configured, such that light emitted at different angles from the light unit along the vertical direction can be effectively converged by means of the two planar portions. Thereby, the light emitted toward the reflective layer and the light-emitting layer may be effectively transmitted along the axis-direction of the light guide bar. As such, the light-emitting uniformity can be guaranteed, and the light utilization rate of the illumination device can be increased. In conclusion, the illumination device described in the embodiments of the invention has favorable light-emitting properties.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An illumination device comprising:
a light guide bar comprising a reflective layer, a light-emitting surface opposite to the reflective layer, and a light-incident surface connecting the reflective layer and the light-emitting surface;
a plurality of light sources located beside the light-incident surface, each of the light sources comprising:
a light unit; and
a lens located between the light unit and the light guide bar, the lens being constituted by two planar portions opposite to each other and two arc-surface portions opposite to each other to surround a light-emitting axis, wherein the two planar portions are adjacent to each other and form a valley line aligned to the light-emitting axis at a junction of the two planar portions, and the two planar portions respectively face the reflective layer and the light-emitting surface with respect to the valley line as a base line, such that at least a portion of light provided by the light unit is emitted toward the reflective layer and the light-emitting surface through the two planar portions, respectively.

2. The illumination device as recited in claim 1, wherein the two planar portions in each of the lenses have an included angle θ at the junction, and the included angle θ ranges from about 90 degrees to about 120 degrees.

3. The illumination device as recited in claim 1, wherein one of the two planar portions in each of the lenses and the reflective layer are located at one side of the light-emitting axis, and the other planar portion and the light-emitting surface are located at the other side of the light-emitting axis.

4. The illumination device as recited in claim 3, wherein one of the two planar portions in each of the lenses is aligned to the reflective layer along a cross-section of an axis of the light guide bar, and the other planar portion and is aligned to the light-emitting surface along the cross-section of the axis of the light guide bar.

5. The illumination device as recited in claim 1, wherein the two arc-surface portions in each of the lenses are respectively adjacent to the two planar portions and respectively aligned to a side of the light-emitting surface located at two sides of the reflective layer along a cross-section of an axis of the light guide bar.

6. The illumination device as recited in claim 1, wherein one of the two planar portions in each of the light sources faces the reflective layer and has a normal vector, and an included angle between the reflective layer and the normal vector of the one of the two planar portions facing the reflective layer ranges from about 45 degrees to about 60 degrees.

7. The illumination device as recited in claim 1, wherein one of the two planar portions in each of the light sources is away from the reflective layer and has a normal vector, and an included angle between the light-emitting layer and the normal vector of the one of the two planar portions away from the reflective layer ranges from about 45 degrees to about 60 degrees.

8. The illumination device as recited in claim 1, wherein an area where the light sources are arranged is smaller than an area of the light-incident surface, and a center of locations of the light sources is aligned to an axis of the light guide bar.

9. The illumination device as recited in claim 1, wherein each of the lenses has a bottom surface, the two planar portions and the two arc-surface portions respectively extend from the valley line to the bottom surface, and the light unit is located at a center of the bottom surface.

10. The illumination device as recited in claim 1, wherein the light-incident surface is located at an end portion of the light guide bar, the light-emitting surface is located on a circumferential surface of the light guide bar, the circumferential surface has a plane parallel to an axis of the light guide bar, and the reflective layer is located on the plane to form a reflective plane.

11. The illumination device as recited in claim 1, wherein the light unit is a light-emitting diode.
